(19) United States
(12) Patent Application Publication
(10) Pub. No.: US 2004/0194751 A1
(43) Pub. Date: Oct. 7, 2004

(54) Suction pipe for an air intake system of an internal combustion engine

(76) Inventors: Hubert Limbrunner, Kirchroth (DE); Wemer Schnabel, Regensburg (DE); Berthold Wolfram, Regensburg (DE)

Correspondence Address: Andreas Grubert, Baker Botts L.L.P., One Shell Plaza, 910 Louisiana, Houston, TX, 77002-4995, US

(21) Appl. No.: 10/756,910

(22) Filed: Jan. 14, 2004

Related U.S. Application Data
(63) Continuation of application No. PCT/DE03/01477, filed on May 8, 2003.

(30) Foreign Application Priority Data
May 14, 2002 (DE) 10221429.8

(51) Int. Cl. F02M 35/10

(52) U.S. Cl. 123/184.61; 123/184.21

(57) ABSTRACT

In a intake system of a combustion engine, surface irregularities in the form of raised parts (8) or depressions (7) are created, at predetermined points, in the wall surfaces of a suction pipe or the surfaces of a flap arranged in such a suction pipe, in order to avoid burbling and eddying in these areas.

### CROSS REFERENCE TO RELATED APPLICATION

This application is a continuation of copending International Application No. PCT/DE03/01477 filed May 8, 2003 which designates the United States, and claims priority to German application DE102 21 429.8 filed May 14, 2002.

### TECHNICAL FIELD OF THE INVENTION

The present invention relates to a suction pipe for an air intake system of an internal combustion engine.

### DESCRIPTION OF THE RELATED ART

In suction pipes for the air intake system of gasoline and diesel internal combustion engines, air or an air/fuel mixture flows at high velocity. To prepare the air/fuel mixture, particularly in the case of internal combustion engines with direct fuel injection, rotatable flaps are inserted near the cylinder head. Corresponding flaps are also used to change the length of the suction pipe. The hydrostatic flow resistance of the suction pipe is dependent, inter alia, on the surface and shape of the pipe wall, but also on the flow resistance of the flap.

The flow velocity of the flow in the suction pipe changes very sharply during the intake operation. In this case, there is a great risk that flow breakaway and vortex formation will occur in specific regions of the suction pipe. Where suction pipes with a smooth wall surface are concerned, the flow velocity range in which a flow with small vortices jumps over into a flow with large vortices is very narrow. The result of this is that a suction pipe suddenly “closes” at a specific flow velocity; this means that a large vortex has occurred. Large vortices not only entail considerable flow losses and therefore a corresponding reduction in efficiency, but also induce high noise level.

Similar situations are also to be observed at the flaps. The flaps mounted rotatably in the suction pipes constitute an obstacle to the flow in the suction pipe.

Flow velocity is usually highest in the region of the flaps. As is known, above all, vortices are formed in the region of the trailing edge of the flap and narrow the effective flow cross section of the suction pipe. In the case of smooth surfaces of the flap, a defined point of flow breakaway cannot be established; thus, it can be observed that, under specific flow conditions, a flow breakaway induces large vortices which abruptly narrow the flow cross section of the suction pipe. Where flaps with a smooth surface are concerned, the flow velocity range in which a flow with small vortices jumps over to a flow with large vortices is very narrow. This likewise leads to the disadvantages already mentioned above, that is to say a reduction in flow efficiency and a disturbing generation of noise.

### SUMMARY OF THE INVENTION

The object on which the present invention is based is to design a suction pipe for an air intake system of an internal combustion engine, in such a way that the risk of flow breakaway and vortex formation and of the generation of noise induced thereby is reduced.

This object can be achieved by means of a suction pipe for an air intake system of an internal combustion engine, comprising at least one flow surface at which there is the risk of flow breakaway and vortex formation, wherein the flow surface is provided at predetermined points, with surface irregularities in the form of elevations and/or depressions in order to avoid flow breakaway and vortex formation.

The depressions can be formed in the manner of a golfball profile. The elevations can be formed as bosses. The surface irregularities can be in the form of shark scales. The elevations and/or depressions can be at nonuniform distances from one another and/or have different shapes. The flow surface, together with the surface irregularities, may consist of plastic. A sucking away of the flow boundary layer can be provided at or adjacently to the points at which the surface irregularities are provided. The flow surface can be a wall surface of the suction pipe. The points at which the surface irregularities are provided may lie at or adjacently to a curve or a shoulder of the wall of the suction pipe. The flow surface can be a surface of a flap which is arranged rotatably in the suction pipe.

The object can also be achieved by a method for producing a flow surface of a suction pipe comprising the step of providing a flow surface at predetermined points, with surface irregularities in the form of elevations and/or depressions in order to avoid flow breakaway and vortex formation, wherein the flow surface, together with the surface irregularities, is produced by plastic molding.

The elevations and/or depressions can be produced by means of a core melt-out method. The depressions and/or elevations can be produced by means of a half-shell casting method.

In the solution according to the invention, flow surfaces at which there is the risk of flow breakaway and vortex formation are provided at predetermined points with surface irregularities in the form of elevations and/or depressions, in order thereby to avoid flow breakaway and vortex formation.

These surface irregularities prevent or at least impede the formation of, above all, large vortices. The suction pipe can thereby be given a minimum flow cross section, without a closing of the flow cross section occurring in the event of a high flow throughput and correspondingly high flow velocities. The invention thus makes it possible to have a considerable improvement in flow efficiency and to avoid the high noise level caused by large vortices.

The points at which surface irregularities are provided are determined by means of calculations and/or tests. Critical points at which the risk of flow breakaway and vortex formation is particularly great are, for example, wall surfaces of the suction pipe in the region of bends or shoulders (steps), such as may occur, for example, due to an offset of mold halves and a casting mold during the production of the suction pipe. Where flaps are concerned, critical points are, in particular, in the region of the trailing edge of the flap.

The surface irregularities may be produced, for example, as depressions in the manner of a golfball profile, as elevations in the form of bosses or else in the form of shark scales. In this case, the elevations and depressions may be distributed uniformly at the respective points. In a further refinement of the invention, however, there is provision for the elevations and/or depressions to be at nonuniform distances from one another and/or to have different shapes. This further reduces the risk of a sudden changeover of the flow from a flow with small vortices into a flow with large vortices.

The surface irregularities provided according to the invention in the form of elevations and depressions can be produced in an especially simple way by plastic molding, for example by means of a core melt-out method or a half-shell casting method.

As already mentioned, the risk of flow breakaway and vortex formation may occur both at the wall surfaces of the suction pipe and at the surfaces of the flaps arranged in the suction pipe. According to the invention therefore, correspondingly formed surface irregularities may be provided at critical points both of the wall surfaces of the suction pipe and of the surfaces of a flap.

### BRIEF DESCRIPTION OF THE DRAWINGS

Further details of the invention may be gathered from the following description of examples, in conjunction with the drawings in which:

FIG. 1 is a diagrammatic sectional illustration of a suction pipe with a flap;

FIG. 2 is a perspective view of the flap in FIG. 1;

FIGS. 3 and 4 are respectively a sectional view and a top view of a first embodiment of surface irregularities;

FIGS. 5 and 6 are respectively a sectional view and a top view of a second embodiment of surface irregularities;

FIGS. 7 and 8 are respectively a sectional view and a top view of a third embodiment of surface irregularities.

### DETAILED DESCRIPTION OF THE PREFERRED EMBODIMENTS

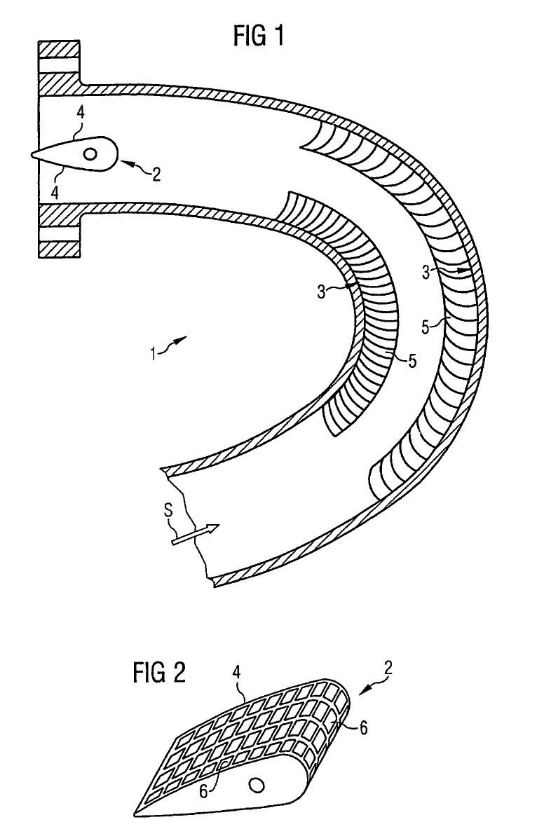

FIG. 1 is a diagrammatic longitudinal section through a suction pipe 1 of an air intake system, otherwise not illustrated, of an internal combustion engine. As shown, the suction pipe 1 has a sharply curved run. The flow direction S is indicated by an arrow. Located in the vicinity of the cylinder head (not shown), that is to say at the downstream end of the suction pipe 1, is a flap 2 which is mounted rotatably about an axis running transversely to the suction pipe 1. Since the basic construction of suction pipes and flaps of this type is known, it is not described in any more detail.

As explained initially, at specific flow surfaces 3, 4 on the wall of the suction pipe 1 or on the surface of the flap 2, the risk that flow breakaway and vortex formation will occur is particularly great. Above all, in these regions, there is the risk that the flow will change over from a flow with small vortices to a flow with large vortices in the event of specific flow throughputs and flow velocities.

In order to avoid this, the flow surfaces 3 and 4 at specific points 5 and 6 are determined by means of calculations and/or by means of tests. In the case of the suction pipe 1 itself, the corresponding points 5 normally lie in regions of a sharp curvature of the suction pipe 1 or at points of the suction pipe at which the wall surface has a shoulder, such as may be caused, for example, by production inaccuracies. Where the flap 2 is concerned, the points 6 may extend essentially over the entire surface of the flap, although the critical region is, in particular, the region of the trailing edge of the flap 2.

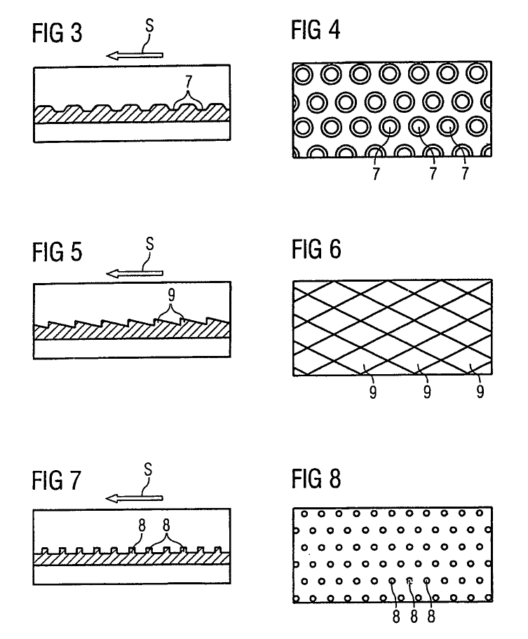

Examples of a possible embodiment of the surface irregularities are illustrated in FIGS. 3 to 8. Thus, in FIGS. 3 and 4, the surface irregularities consist of depressions 7 which are formed in the manner of a golfball profile. In FIGS. 5 and 6, the surface irregularities are formed by “shark scales” 9. In FIGS. 7 and 8, the surface irregularities consist of elevations 8 which are in the form of bosses.

These surface irregularities generate small vortices which make the flow as it were stable, so that the risk of the formation of large vortices is avoided or at least reduced. As indicated in FIGS. 7 and 8, it may be expedient, in this case, to distribute the elevations 8 (or the depressions 7) nonuniformly. This means that they are at uniform distances from one another and/or have irregular shapes.

The points 5 and 6 at which the surface irregularities are provided may be assigned a device for sucking away the flow boundary layer (not shown), in order thereby further to reduce the risk of flow breakaway and vortex formation.

Expediently, the suction pipe 1 and the flap 2 are produced from plastic by molding. Since plastic parts have basically very smooth surfaces, it is particularly expedient, in this case, to provide corresponding surface irregularities. Plastic molding methods in this case afford an especially simple possibility of introducing surface irregularities according to FIGS. 3 to 8 at the points 5 and 6 of the suction pipe 1 and the flap 2 during the production process. In this case, for example, a core melt-out method or a half-shell casting method may be considered. By means of these methods, the shark scales 9 according to FIGS. 5 and 6 can also be produced, in which case the shark scales may be backed by means of parting lines caused by a separation with the casting mold.

It goes without saying, however, that other production methods may also be used. Moreover, it may be pointed out that FIGS. 3 to 8 show only some examples of possible surface irregularities, since numerous other embodiments are possible.

We claim:

1. A suction pipe for an air intake system of an internal combustion engine, comprising at least one flow surface at which there is the risk of flow breakaway and vortex formation, wherein the flow surface is provided at predetermined points, with surface irregularities in the form of elevations and/or depressions in order to avoid flow breakaway and vortex formation.

2. The suction pipe as claimed in claim 1, wherein the depressions are formed in the manner of a golfball profile.

3. The suction pipe as claimed in claim 1, wherein the elevations are formed as bosses.

4. The suction pipe as claimed in claim 1, wherein the surface irregularities are in the form of shark scales.

5. The suction pipe as claimed in claim 1, wherein the elevations and/or depressions are at nonuniform distances from one another and/or have different shapes.

6. The suction pipe as claimed in claim 1, wherein the flow surface, together with the surface irregularities, consist of plastic.

7. The suction pipe as claimed in claim 1, wherein a sucking away of the flow boundary layer is provided at or adjacently to the points at which the surface irregularities are provided.

8. The suction pipe as claimed in claim 1, wherein the flow surface is a wall surface of the suction pipe.

9. The suction pipe as claimed in claim 8, wherein the points at which the surface irregularities are provided lie at or adjacently to a curve or a shoulder of the wall of the suction pipe.

10. The suction pipe as claimed in claim 1, wherein the flow surface is a surface of a flap which is arranged rotatably in the suction pipe.

11. A method for producing a flow surface of a suction pipe comprising the step of providing a flow surface at predetermined points, with surface irregularities in the form of elevations and/or depressions in order to avoid flow breakaway and vortex formation, wherein the flow surface, together with the surface irregularities, is produced by plastic molding.

12. The method as claimed in claim 11, wherein the elevations and/or depressions are produced by means of a core melt-out method.

13. The method as claimed in claim 11, wherein the depressions and/or elevations are produced by means of a half-shell casting method.
